(19) United States
(12) Patent Application Publication
(10) Pub. No.: US 2016/0125457 A1
(43) Pub. Date: May 5, 2016

(54) METHOD OF PROVIDING PRODUCT USING APPLICATION AND SYSTEM AND APPARATUS FOR THE SAME

(71) Applicant: SK PLANET CO., LTD., Seongnam-si, Gyeonggi-do (KR)

(72) Inventor: Jonghee JUNG, Yongin-si, Gyeonggi-do (KR)

(21) Appl. No.: 14/891,918

(22) PCT Filed: Dec. 2, 2014
(86) PCT No.: PCT/KR2014/011719

§ 371 Date: Nov. 17, 2015

(30) Foreign Application Priority Data
Mar. 26, 2014 (KR) 10-2014-0035334

(51) Int. Cl. G06Q 30/02; G06Q 30/06

(52) U.S. Cl. CPC G06Q 30/0253; G06Q 30/0601

(57) ABSTRACT

The present invention relates to a method of providing a product using an application, and a system and an apparatus for the same. In particular, by providing product information related to a product displayed on an execution screen of a game or an application and a link to a sales site in which it is possible to purchase the product, the information related to a product displayed on an execution screen provided through the game or the application is provided. Also, when advertising information corresponding to the product information is selected, discount information of the product is additionally provided. Therefore, it is possible to simplify a procedure for a product purchase and increase benefits from the product purchase. In addition, product sellers can expose their products to innumerable game or application users. Further, users can purchase products matching their interests at low prices.

### CROSS-REFERENCE TO RELATED APPLICATION

This application claims priority to and the benefit of Korean Patent Application No. 10-2014-0035334 filed in the Korean Intellectual Property Office on Mar. 26, 2014, the entire contents of which are incorporated herein by reference.

### TECHNICAL FIELD

The present invention relates to a method of providing a product using an application, and a system and an apparatus for the same, and more particularly, to a method of providing a product using an application that provides product information related to a product displayed on an execution screen of a game or an application and a link to a sales site in which it is possible to purchase the product, and a system and an apparatus for the method.

### BACKGROUND

With the development of a mobile communication network and terminal specifications, a mobile communication terminal has broken the scope of existing mere communication devices or information providing devices and become a necessary item for modern people, and there is a trend toward evolving mobile communication terminals into total entertainment devices.

In particular, as society undergoes division of labor and is specialized, production, distribution, and sales structures of products are being enhanced and systematized. Also, in the production stage of a product, it has become commonplace that an assembly company buys components produced by a plurality of component manufacturers and makes one consumer product.

Through off-line markets, such as department stores/discount stores, which are traditional product distribution markets, business-to-business (B2B) markets of electronic (e)-commerce between companies, and business-to-consumer (B2C) e-commerce markets, such as Internet shopping malls, which are on-line digital markets, we have experienced how great a crowd of consumers, that is, the power of consumers, is and how important a role the crowd of consumers plays.

However, although consumers are the most powerful distribution subject in a relationship among manufacturers, distributors, and consumers, which is a chain of distribution subjects for product distribution, consumers cannot take their shares. In other words, although consumers are able to get earnings by taking an active role in product distribution through the power of a consumer group and making a distribution profit, and to purchase products at lower prices, they actually have not played such a role.

Therefore, e-commerce based on a new paradigm which enables consumers to make direct dealings with manufacturers and hold markets led by the consumers on the wired/wireless Internet is required so that a consumer cannot only make a distribution profit as a digital distributor but also can purchase a product at a remarkably low price.

In addition, to purchase a product provided on an execution screen of a game or an application of a terminal, there is the inconvenience of stopping execution or closing the game or the application, accessing a product sales site, searching for the product, and then purchasing the product.

### SUMMARY

The present invention is directed to providing a solution to the inconvenience of stopping execution of a game or an application of a terminal or closing the game or the application, accessing a product sales site, searching for a product provided on an execution screen of the game or the application, and then purchasing the product.

The present invention is directed to providing a method of providing a product using an application capable of providing information related to a product displayed on an execution screen of a game or an application and a link to a sales site in which it is possible to purchase the product, and a system and an apparatus for the method.

One aspect of the present invention provides a service apparatus including a service communication unit configured to transceive data for providing an application and data related to product sales through the application by communicating with at least one terminal, and a service controller configured to collect and provide information on at least one product related to an execution screen provided through the application, check advertising information corresponding to the collected product information according to a request of the terminal during execution of the application, provide detailed information on the advertising information when the advertising information is selected, and make a sale of the product according to a request of the terminal.

The service apparatus according to the present invention may further include a service storage configured to store the execution screen provided through the application, the product information provided on the execution screen, the advertising information related to the product information, and detailed information matched to the advertising information.

In the service apparatus according to the present invention, the service controller may check products previously registered in a product pool by a plurality of product sellers, select the at least one product to apply to the application from among the products registered in the product pool, and apply the selected product to the application.

In the service apparatus according to the present invention, the service controller may request a plurality of product sellers to register a specific product, or may be requested to register the specific product by the product sellers and determine whether or not to register the product.

In the service apparatus according to the present invention, the service controller may automatically select an optimal product by checking at least one of a keyword, a target person, and user information of a product matched to the specific application, and apply the selected product to the application.

Another aspect of the present invention provides a terminal including a communication unit configured to transceive data for executing an application and data related to a product purchase through the application by communicating with a service apparatus, and a controller configured to execute the application, receive advertising information corresponding to information on at least one product displayed on an execution screen provided through the application from the service apparatus, request the product information related to the advertising information when the advertising information is selected, display detailed information on the advertising information received from the service apparatus in response to the request, access a sales site matched to the product, and make a purchase of the product.

The terminal according to the present invention may further include a display unit configured to output the execution screen of the application and output at least one piece of the advertising information on the execution screen.

In the terminal according to the present invention, the controller may request the service apparatus to charge for the specific product, receive discount information related to the product from the service apparatus, check the discount information, and use the discount information to make a payment for the product through the sales site.

Another aspect of the present invention provides a system for providing a product using an application, the system including a terminal configured to execute an application, receive advertising information corresponding to information on at least one product from a service apparatus while executing a game using the application, request the product information related to the advertising information from the service apparatus when the advertising information is selected, display detailed information on the advertising information received from the service apparatus in response to the request, access a sales site matched to the product, and make a purchase of the product, and the service apparatus configured to provide the application to the terminal, collect and provide the information on the at least one product related to the game provided through the application, check the advertising information corresponding to the collected product information according to the request of the terminal during execution of the game, provide the product information on the advertising information when the advertising information is selected, and make a sale of the product according to a request of the terminal.

Another aspect of the present invention provides a method of providing a product using an application, the method including providing, by a service apparatus, an application to at least one terminal, collecting, by the service apparatus, information on at least one product related to a game provided through the application, checking, by the service apparatus, advertising information corresponding to the collected product information according to a request of the terminal during execution of the application, transmitting, by the service apparatus, the advertising information to the terminal, providing, by the service apparatus, detailed information on the advertising information when the advertising information is selected, and making, by the service apparatus, a sale of the product according to a request of the terminal.

In the method of providing a product using an application according to the present invention, the collecting of the product information may further include retrieving, by the service apparatus, a product matched to at least one of a user tendency and a supporting language and country corresponding to at least one of a game keyword, a total number of downloads, a daily number of users, a target sex, a target age band, and a country-specific download ratio.

In the method of providing a product using an application according to the present invention, the product information may include information corresponding to at least one of a product name, a detailed page uniform resource locator (URL), a product image, a category, a quantity, and a time limit.

In the method of providing a product using an application according to the present invention, the making of the sale may include receiving, by the service apparatus, a signal for requesting payment for the specific product from the terminal, checking, by the service apparatus, discount information related to the product according to the request, transmitting, by the service apparatus, the checked discount information to the terminal, and making, by the service apparatus, the sale of the product through a sales site using the discount information.

Another aspect of the present invention provides a method of providing a product using an application, the method including executing, by a terminal, an application, receiving, by the terminal, advertising information corresponding to information on at least one product from a service apparatus while executing a game using the application, requesting, by the terminal, the product information related to the advertising information from the service apparatus when the advertising information is selected, displaying, by the terminal, detailed information on the advertising information received from the service apparatus in response to the request, and accessing, by the terminal, a sales site matched to the product and making a purchase of the product.

In the method of providing a product using an application according to the present invention, the receiving of the advertising information may further include outputting, by the terminal, the advertising information received from the service apparatus on a game execution screen.

Another aspect of the present invention provides a computer-readable recording medium storing a program for performing operations of providing an application to at least one terminal, collecting information on at least one product related to a game provided through the application, checking advertising information corresponding to the collected product information according to a request of the terminal during execution of the game, transmitting the advertising information to the terminal, providing detailed information on the advertising information when the advertising information is selected, and making a sale of the product according to a request of the terminal.

Another aspect of the present invention provides a computer-readable recording medium storing a program for performing operations of executing an application, receiving advertising information corresponding to information on at least one product from a service apparatus while executing a game using the application, requesting the product information related to the advertising information from the service apparatus when the advertising information is selected, displaying detailed information on the advertising information received from the service apparatus in response to the request, and accessing a sales site matched to the product to make a purchase of the product.

According to the present invention, by providing product information related to a product displayed on an execution screen provided through a game or an application and additionally providing discount information of the product when advertising information corresponding to the product information is selected, it is possible to simplify a procedure for a product purchase and increase benefits from the product purchase.

In addition, product sellers can expose their products to innumerable game or application users.

Further, users can purchase products matching their interests at low prices.

### BRIEF DESCRIPTION OF DRAWINGS

FIG. 1 is a diagram showing a configuration of a system for providing a product using an application according to embodiments of the present invention.

FIG. 2 is a block diagram showing a configuration of a terminal according to the present invention.

FIG. 3 is a block diagram showing a configuration of a service apparatus according to the present invention.

FIG. 4 is a flowchart illustrating an operation method of a terminal according to embodiments of the present invention.

FIG. 5 is a flowchart illustrating an operation method of a service apparatus according to embodiments of the present invention.

FIGS. 6A to 6D are example diagrams illustrating a method of providing a product using an application according to embodiments of the present invention.

### DETAILED DESCRIPTION

Hereinafter, exemplary embodiments of the present invention that enable those of ordinary skill in the art of the present invention to easily implement the present invention will be described in detail with reference to the accompanying drawings. In the detailed description of exemplary embodiments of the present invention, when detailed descriptions on the known art related to the present invention are determined to unnecessarily obscure the gist of the present invention, the detailed descriptions will be omitted. Throughout the drawings, like elements are referred to by like numerals within the limits of the possible.

Terms or words used in this specification and claims described below are not to be construed as common or dictionary meanings but are to be construed as meanings and concepts in accordance with the technical spirit of the present disclosure based on a principle that the inventor can define terms appropriately for the best explanation of his or her own disclosure. Embodiments described in the present specification and configurations shown in the drawings are merely exemplary embodiments or the present invention and do not represent all the technical spirit of the present invention. Thus, it is to be understood that there can be various equivalents and modifications to the filing data of the present invention.

As a representative example of a terminal according to embodiments of the present invention, a mobile communication terminal that is connected to a communication network to execute an on-line game or application and purchase a product provided on an execution screen is described below. However, the terminal is not limited to a mobile communication terminal, and can be various terminals such as any information communication device, a multimedia terminal, a wired terminal, a fixed terminal, and an Internet protocol (IP) terminal. Also, when the terminal is a mobile terminal having various mobile communication specifications, such as a cellular phone, a portable multimedia player (PMP), a mobile Internet device (MID), a smart phone, a desktop, a tablet personal computer (PC), a laptop computer, a net book, and an information communication device, the terminal can be advantageously used.

Operation of the present invention is described using a game application as an application according to embodiments of the present invention. However, the application is not limited to a game application, and may be various types of applications.

A product sales system 100 using an application according to embodiments of the present invention will be described below.

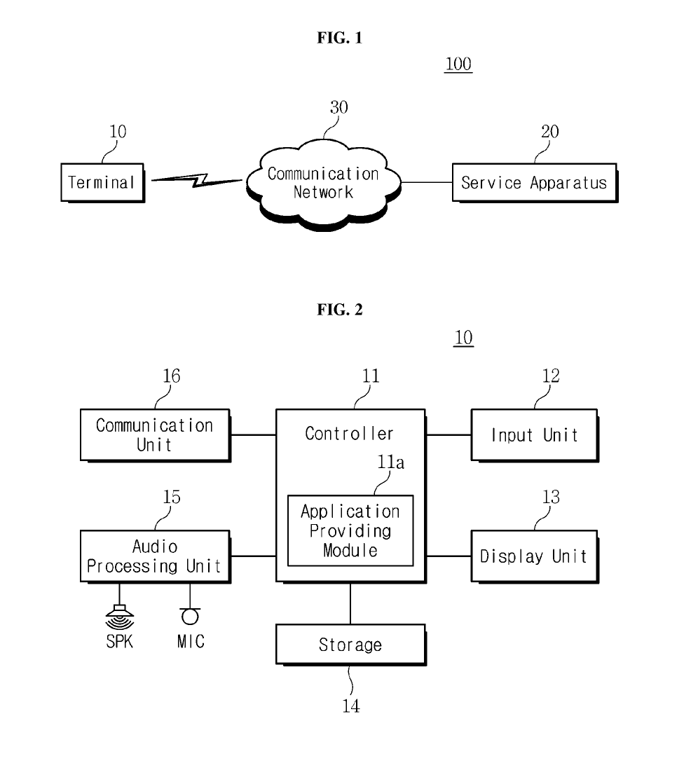

FIG. 1 is a diagram showing a configuration of a system for providing a product using an application according to embodiments of the present invention.

A terminal 10 according to the present invention or a processor installed in a service apparatus 20 may process program instructions for performing a method according to the present invention. In an embodiment, the processor may be a single-threaded processor, and in another embodiment, the processor may be a multi-threaded processor. Further, the processor can process instructions stored in a memory or a storage device.

A communication network 30 performs a series of data transmission and reception operations for data transmission and information exchange between the terminal 10 and the service apparatus 20. In particular, various forms of communication networks may be used as the communication network 30. For example, it is possible to use a wireless communication method, such as a wireless local area network (WLAN), wireless-fidelity (WiFi), wireless broadband (WiBro) network, worldwide interoperability for microwave access (WiMax), high speed downlink packet access (HSDPA), etc., or a wired communication method, such as Ethernet, digital subscriber line (xDSL; asymmetric digital subscriber line (ADSL) or very high bit rate digital subscriber line (VDSL)), hybrid fiber coaxial (HFC), fiber to the curb (FTTC), fiber to the home (FTTH), etc. The communication network 30 is not limited to the aforementioned communication methods, and may include other widely known communication methods and any communication methods that are developed in the future in addition to the aforementioned communication methods.

The terminal 10 is connected to the service apparatus 20 through the communication network 30, thereby transceiving all data related to a product purchase through a game or an application. In particular, the terminal 10 according to the present invention executes the game or the application. Then, from the service apparatus 20, the terminal 10 receives advertising information corresponding to information on at least one product related to current progress among execution screens provided as the game or the application is executed. Subsequently, the terminal 10 displays the received advertising information on one side of the screen.

When the advertising information displayed on the screen is selected by a user's input, the terminal 10 requests product information related to the advertising information from the service apparatus 20. Then, the terminal 10 receives a response to the request from the service apparatus 20, and displays detailed information on the received advertising information. Subsequently, the terminal 10 accesses a sales site matched to the product and performs a purchase procedure for the product.

The service apparatus 20 is connected to the terminal 10 through the communication network 30, thereby transceiving all data related to sales of a product displayed on an execution screen during execution of the game or the application. In particular, the service apparatus 20 according to the present invention provides the game or the application to the terminal 10, collects the product information related to the product displayed on the execution screen, and provides the collected product information to the terminal 10.

According to a request of the terminal 10, the service apparatus 20 checks advertising information corresponding to the product information during execution of the game or the application. Then, when a signal for selecting the advertising information is received from the terminal 10, the service apparatus 20 provides the detailed information on the advertising information to the terminal 10. Subsequently, the service apparatus 20 performs a sales procedure for the product.

To match products to the application, the service apparatus 20 checks products which have been previously registered in a product pool by a plurality of product sellers, and selects at least one product to apply to the application from among the products which have been registered in the product pool. Then, the service apparatus 20 applies the selected product to the application. At this time, the service apparatus 20 may request a plurality of product sellers to register the specific product, and receive response signals corresponding to acceptances or denials of registration of product advertisements from the product sellers. On the other hand, the service apparatus 20 may be requested to register the specific product by product sellers, and may determine whether or not to register (accept or deny) the product. Here, such a configuration is manually operated.

Meanwhile, to automatically match products to applications, the service apparatus 20 collects at least one piece of information among keywords, targets, and user information of products from a database (DB), and automatically matches products to optimal applications based on the collected information.

In this way, by providing product information related to a product displayed on an execution screen provided through a game or an application and additionally providing discount information of the product when advertising information corresponding to the product information is selected, the present invention can simplify a procedure for a product purchase and increase benefits from the product purchase. In addition, product sellers can expose their products to innumerable game or application users. Further, users can purchase products matching their interests at low prices.

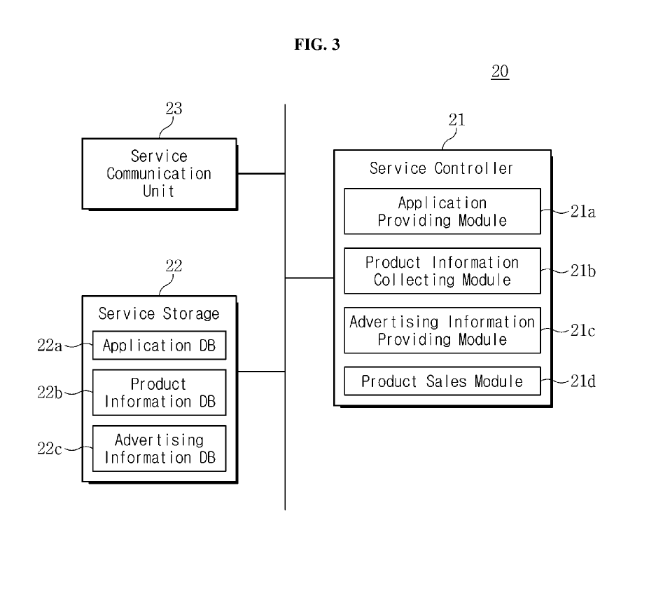

The above-described process of providing a product using an application according to embodiments of the present invention will be described in further detail with reference to FIGS. 2 to 6D.

FIG. 2 is a block diagram showing a configuration of a terminal according to the present invention.

Referring to FIG. 2, the terminal 10 according to the present invention includes a controller 11, an input unit 12, a display unit 13, a storage 14, an audio processing unit 15, and a communication unit 16. Here, the controller 11 includes an application providing module 11a.

The input unit 12 receives various information, such as numerical and text information, sets a variety of functions, and transfers a signal input in relation to functional control of the terminal 10 to the controller 11. Also, the input unit may be configured to include at least one of a key pad and a touch pad which generate an input signal according to the user's touch or manipulation. Then, the input unit 12 may be configured in the form of a touch panel (or a touch screen) together with the display unit 13, thereby performing input and display functions simultaneously. In addition to input devices such as a keyboard, a key pad, a mouse, and a joystick, any input tools that are developed in the future may be used as the input unit 12. In particular, the input unit 12 senses an input signal for executing a game or an application, an input signal for selecting advertising information during execution of a game or an application, an input signal for purchasing a product, etc., and transfers the signals to the controller 11.

The display unit 13 displays information on a series of operation states, operation results, etc. generated while a function of the terminal 10 is performed. Also, the display unit 13 may display a menu of the terminal 10 and user data input by the user, and so on. Here, the display unit 13 may be a liquid crystal display (LCD), a thin film transistor (TFT)-LCD, a light-emitting diode (LED) display, an organic LED (OLED) display, an active matrix OLED (AMOLED) display, a retina display, a flexible display, a three-dimensional (3D) display, or so on. When the display unit 13 is configured in the form of a touch screen, the display unit 13 may perform all or some functions of the input unit 12. In particular, the display unit 13 according to the present invention outputs an execution screen of a game or an application and a screen of advertising information received during execution of the game or the application.

The storage 14 is a device for storing data. The storage 14 includes a main memory and an auxiliary memory, and stores application programs required for functional operations of the terminal 10. The storage 14 may roughly include a program area and a data area. Here, when the terminal 10 activates respective functions according to the user's request, the terminal 10 executes the corresponding application programs under the control of the controller 11, thereby providing the respective functions. In particular, the storage 14 according to the present invention stores an operating system (OS) for booting the terminal 10, a program for executing a game, a program for executing an application, and so on. Also, the storage 14 stores data for executing a game or an application.

The audio processing unit 15 performs a function of transferring an audio signal input from a speaker SPK or microphone MIC for playing and outputting an audio signal to the controller 11. The audio processing unit 15 may convert the analog audio signal input through the microphone MIC into a digital audio signal and transfer the digital audio signal to the controller 11. Also, the audio processing unit 15 may convert a digital audio signal output from the controller 11 into an analog signal and output the analog signal through the speaker SPK. In particular, the audio processing unit 15 according to the present invention outputs sound effects or execution sound according to execution of a game or an application.

The communication unit 16 performs a function for exchanging data with the service apparatus 20 through the communication network 30. Here, the communication unit 16 includes a radio frequency (RF) transmitting tool which up-converts and amplifies the frequency of a signal to be transmitted, an RF receiving tool which amplifies a received signal with low noise and down-converts the frequency, and so on. The communication unit 16 may include at least one of a wireless communication module (not shown) and a wired communication module (not shown). The wireless communication module is a component for transceiving data according to a wireless communication method. When the terminal 10 uses wireless communication, it is possible to exchange data with the service apparatus 20 using any one of a wireless network communication module, a WLAN communication module, and a wireless personal area network (WPAN) communication module. Also, the wired communication module is used to transceive data through a wire. The wired communication module may access the communication network 30 through a wire, thereby exchanging data with the service apparatus 20. In particular, the communication unit 16 according to the present invention communicates with the service apparatus 20, thereby transceiving data for a game or an application and data related to a product purchase through the game or the application.

The controller 11 may be a process device which runs the OS and respective components. In particular, the controller 11 according to embodiments of the present invention executes a game or an application provided by the service apparatus 20. On the other hand, the controller 11 may execute a game or an application installed in the terminal 10. Also, the controller 11 receives advertising information corresponding to product information related to a product displayed on the screen during execution of a game or an application from the service apparatus 20. Here, the controller 11 outputs the advertising information received from the service apparatus 20 on an execution screen of the game or the application. For example, the product information includes information corresponding to at least one of a product name, a detailed page uniform resource locator (URL), a product image, a category (a price, an expiration date, a quantity, etc.), and a time limit.

When the advertising information is selected by the user, the controller 11 requests detailed information related to the advertising information from the service apparatus 20. Here, the detailed information includes information on a product purchase site, a discount rate for purchase, a price, and so on. Then, the controller 11 receives detailed information on the advertising information from the service apparatus 20, and displays the received detailed information on the screen.

Subsequently, the controller 11 accesses a sales site matched to the product and performs a purchase procedure for the product. Here, the controller 11 requests payment for the product from the service apparatus 20, and receives discount information related to the product from the service apparatus 20. Here, a wallet application, etc. may be applied to the payment as a payment tool.

The controller 11 checks the received discount information, and applies the discount information to a product price to make the payment for the product through the sales site.

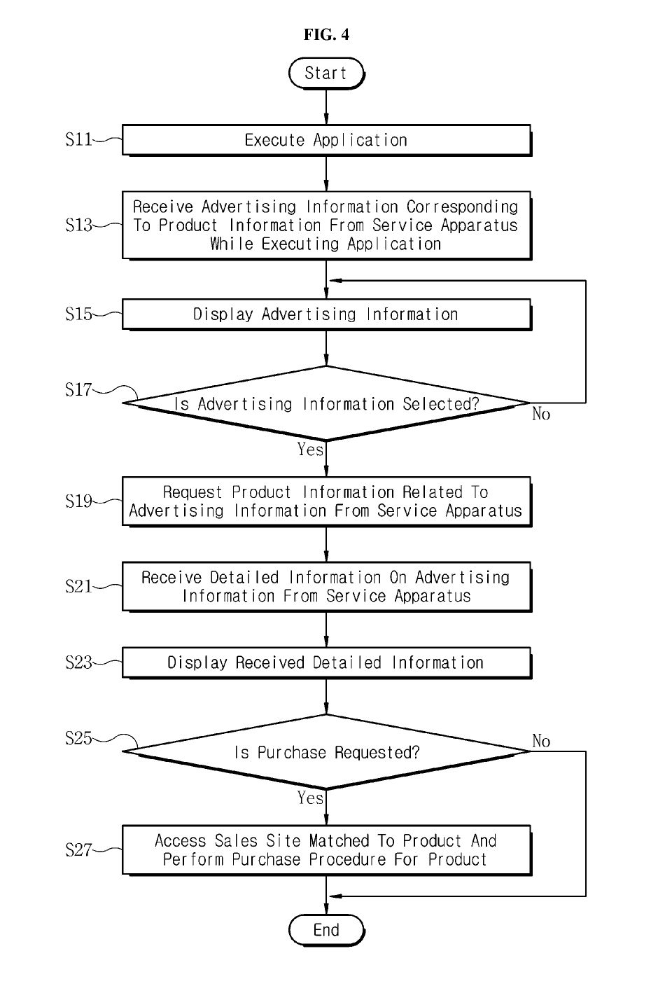

FIG. 3 is a block diagram showing a configuration of a service apparatus according to the present invention.

Referring to FIG. 3, the service apparatus 20 according to the present invention includes a service controller 21, a service storage 22, and a service communication unit 23. Here, the service controller 21 includes an application providing module 21a, a product information collecting module 21b, an advertising information providing module 21c, and a product sales module 21d, and the service storage 22 includes an application DB 22a, a product information DB 22b, and an advertising information DB 22c.

The service communication unit 23 communicates with the terminal 10 through the communication network 30, thereby transceiving data for a game or an application and data related to product sales through the game or the application.

The service storage 22 stores all programs in accordance with the execution of functions of the service apparatus 20. In particular, the service storage 22 according to the present invention stores a program for providing a game, a program for providing an application, a program for collecting product information of a product displayed on an execution screen during execution of the game or the application, a program for providing advertising information matched to the product information, a program for selling the product related to the advertising information provided during execution of the game or the application according to a request of the terminal 10, and so on. Also, the service storage 22 includes the application DB 22a which stores data of an application provided to the terminal 10, the product information DB 22b which stores the product information related to the product displayed on the execution screen of the game or the application, and the advertising information DB 22c which stores advertising information corresponding to the product information.

The service controller 21 may be a process device that runs the OS and respective components. In particular, the service controller 21 according to embodiments of the present invention provides a game or an application to the terminal 10.

The service controller 21 collects product information related to products displayed on execution screens provided through a game or an application. Here, the service controller 21 retrieves products matched to at least one of a user tendency and a supporting language and country (Korean/English/Japanese/Chinese, Korea/US/Japan/China) corresponding to at least one of a game keyword (golf, baseball, automobile, fashion, beauty, cosmetics, etc.), the total number of downloads, the daily number of users, a target sex, a target age band (teens, twenties, thirties, forties, etc.), and a country-specific download ratio. For example, the product information includes information corresponding to at least one of a product name, a detailed page URL, a product image, a category (a price, an expiration date, or a quantity), and a time limit.

The service controller 21 checks advertising information corresponding to the collected product information according to a request of the terminal 10 during execution of the game or the application. Then, the service controller 21 transmits the checked advertising information to the terminal 10. When a signal for selecting the advertising information is received from the terminal, the service controller 21 provides detailed information on the advertising information. At this time, the service controller 21 provides detailed information such as information on a product purchase site, a discount rate for purchase, a price, and so on.

The service controller 21 performs a sales procedure based on the product information according to a request of the terminal 10. Here, the service controller 21 receives a signal for requesting payment for the specific product from the terminal 10, and checks discount information related to the product according to the request. Then, the service controller 21 transmits checked discount information to the terminal 10, and applies the discount information to a product price to make a sale of the product through the sales site.

To match products to an application, the service controller 21 checks products which have been previously registered in a product pool by a plurality of product sellers, and selects at least one product to apply to the application from among the products which have been registered in the product pool. Then, the service controller 21 applies the selected product to the application. At this time, the service controller 21 may request a plurality of product sellers to register the specific product, and receive response signals corresponding to acceptances or denials of registration of product advertisements from the product sellers. On the other hand, the service controller 21 may be requested to register the specific product by product sellers, and may determine whether or not to register (accept or deny) the product. Here, such a configuration is manually operated.

Meanwhile, to automatically match products to applications, the service controller 21 collects at least one piece of information among keywords, targets, and user information of products from a DB, and automatically matches products to optimal applications based on the collected information.

The service apparatus 20 configured as described above may be embodied as one or more servers that operate using server-based computing or cloud computing. In particular, data for executing a game may be provided through a cloud computing function whereby the data can be permanently stored in a cloud computing device on the Internet. Here, cloud computing denotes a technology for serving digital terminals, such as a desktop, a tablet PC, a laptop computer, a net book, a smart phone, etc., with virtualized information technology (IT) resources, for example, hardware (a server, a storage, a network, etc.), software (a DB, security, a web server, etc.), service, data, etc., in an on-demand manner using Internet technology.

Meanwhile, a memory installed in the terminal 10 or the service apparatus 20 stores information in the corresponding device. In an embodiment, the memory is a computer-readable medium. In an embodiment, the memory may be a volatile memory unit, and in another embodiment, the memory may be a non-volatile memory unit. In an embodiment, a storage may be a computer-readable medium. In various different embodiments, the storage may be, for example, a hard disk device, an optical disk device, and other large-capacity storage devices.

Although examples of device configurations are described in this specification and the drawings, embodiments of functional operations and subject matters described in this specification can be implemented in different types of digital electronic circuitry, implemented in computer software, firmware, or hardware including a structure disclosed in this specification and its equivalents, or implemented in a combination of one or more of these. Embodiments of the subject matter described in this specification may be implemented as one or more computer program products, that is, one or more modules related to computer program instructions encoded in a program storage medium to control operation of an apparatus according to the present invention or to be run by the operation. The computer-readable medium may be a machine-readable storage device, a machine-readable storage substrate, a memory device, a composition of material having an influence on a machine-readable radio wave signal, or a combination of one or more of these.

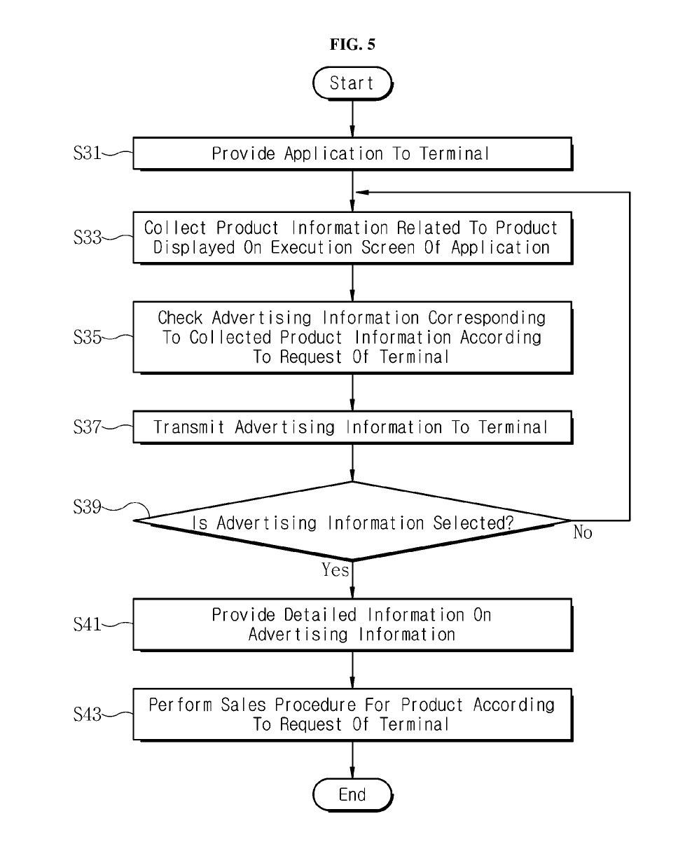

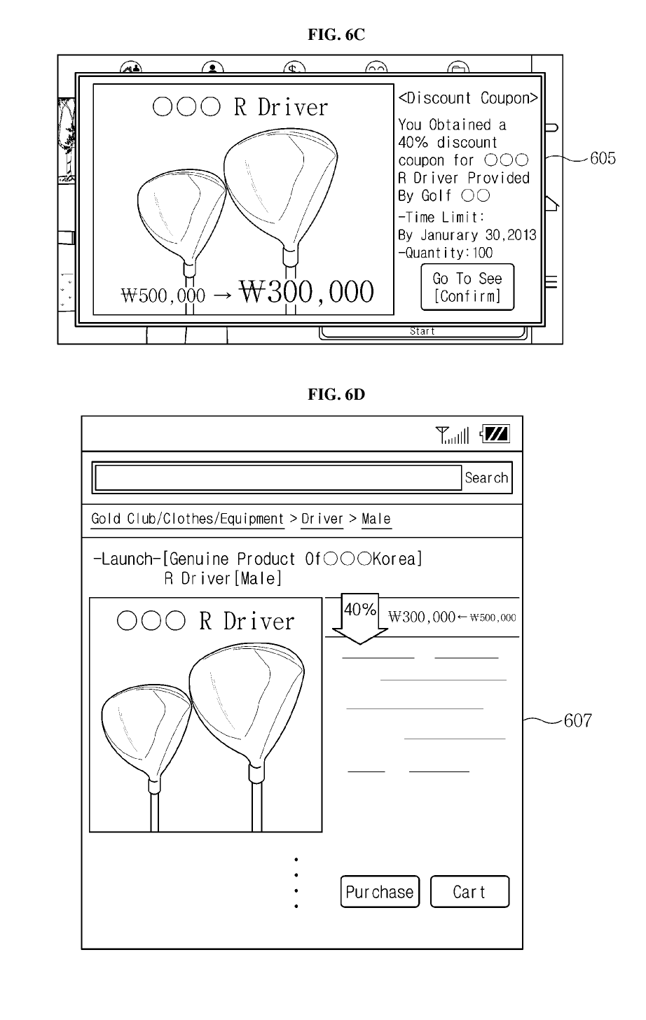

FIG. 4 is a flowchart illustrating an operation method of a terminal according to embodiments of the present invention, and FIGS. 6A to 6D are example diagrams illustrating a method of providing a product using an application according to embodiments of the present invention.

Referring to FIG. 4, in operation S11 of a method of providing a product using an application according to the present invention, the terminal 10 executes a game or an application. In operation S13, the terminal 10 receives advertising information corresponding to product information related to a product displayed on an execution screen while executing the game or the application from the service apparatus 20. Subsequently, in operation S15, the terminal 10 outputs the advertising information received from the service apparatus 20 on the execution screen. For example, the product information includes information corresponding to at least one of a product name, a detailed page URL, a product image, a category, a quantity, and a time limit.

In operation S17, the terminal 10 determines whether the advertising information is selected. When the advertising information is selected, the terminal 10 requests detailed information related to the advertising information from the service apparatus 20 in operation S19. Then, in response to the request, the terminal 10 receives detailed information from the service apparatus 20, and displays the detailed information on the advertising information (S21 and S23). Here, the terminal 10 provides information on a product purchase site, a discount rate for purchase, a price, etc. as the detailed information.

In operation S25, the terminal 10 determines whether a purchase of the selected product is requested. In operation S27, the terminal 10 accesses a sales site matched to the product and performs a purchase procedure for the product. Here, the terminal 10 requests payment for the specific product from the service apparatus 20, and receives discount information related to the product from the service apparatus 20. After that, the terminal 10 checks the discount information, and applies the discount information to the product price to make a payment for the product through the sales site. At this time, the sales site may be an on-line shopping mall, an open market, or so on.

For example, as shown in FIGS. 6A to 6D, the terminal 10 outputs advertising information 603 on one side of execution screen of a game or an application 601. When the advertising information 603 is selected according to a user's request, the terminal 10 provides detailed information on the advertising information on a screen 605 and simultaneously outputs discount information. Subsequently, when a purchase of the corresponding product is requested, the terminal 10 accesses a sales site in which it is possible to purchase the product, displays a sales site screen 607, and performs a purchase procedure for the product through the sales site.

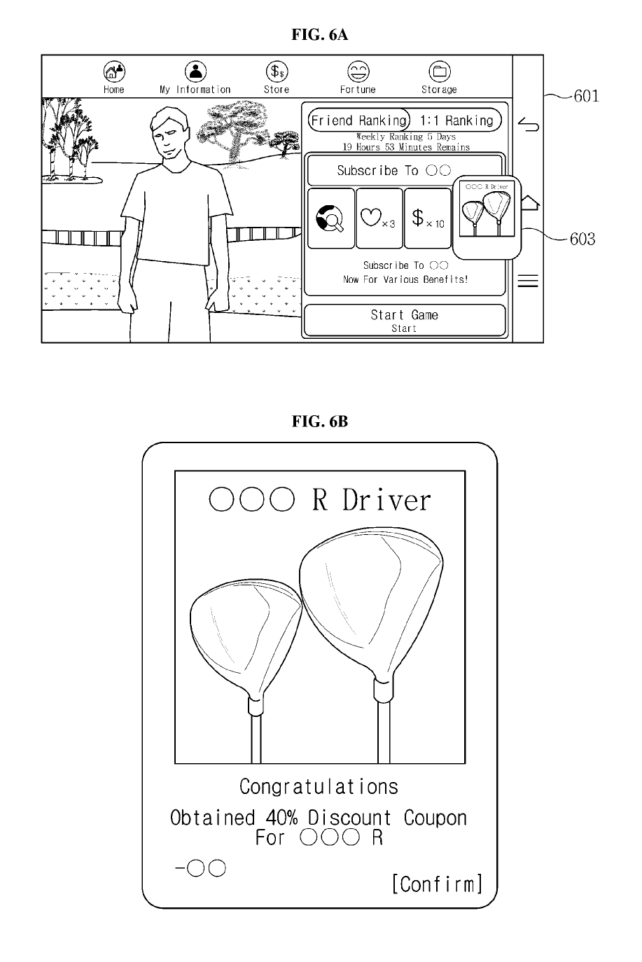

FIG. 5 is a flowchart illustrating an operation method of a service apparatus according to embodiments of the present invention.

Referring to FIG. 5, in operation S31 of a method of providing a product using an application according to the present invention, the service apparatus 20 provides a game or an application to the terminal 10. In operation S33, the service apparatus 20 collects product information related to a product displayed on an execution screen of the game or the application. Here, the service apparatus 20 retrieves a product matched to at least one of a user tendency and a supporting language and country corresponding to at least one of a game keyword, a total number of downloads, a daily number of users, a target sex, a target age band, and a country-specific download ratio. For example, the product information includes information corresponding to at least one of a product name, a detailed page URL, a product image, a category, a quantity, and a time limit.

In operation S35, the service apparatus 20 checks advertising information corresponding to the collected product information during execution of the game or the application according to a request of the terminal 10. Then, in operation S37, the service apparatus 20 transmits the checked advertising information to the terminal 10.

In operation S39, the service apparatus 20 checks whether the advertising information is selected in the terminal 10. When the advertising information is selected, the service apparatus 20 provides detailed information on the advertising information in operation S41. At this time, the service apparatus 20 provides detailed information such as information on a product purchase site, a discount rate for purchase, a price, and so on. Subsequently, in operation S43, the service apparatus 20 performs a sales procedure based on the product information according to a request of the terminal 10. Here, the service apparatus 20 receives a signal for requesting payment for the specific product from the terminal 10, and checks discount information related to the product according to the request. Then, the service apparatus 20 transmits the checked discount information to the terminal 10, and applies the discount information to the product price to make a sale of the product through the sales site.

To match products to an application, the service apparatus 20 checks products which have been previously registered in a product pool by a plurality of product sellers, and selects at least one product to apply to the application from among the products which have been registered in the product pool. Then, the service apparatus 20 applies the selected product to the application. At this time, the service apparatus 20 may request a plurality of product sellers to register a specific product, and receive response signals corresponding to acceptances or denials of registration of product advertisements from the product sellers. On the other hand, the service apparatus 20 may be requested to register the specific product by product sellers, and may determine whether or not to register (accept or deny) the product. Here, such a configuration is manually operated.

Meanwhile, to automatically match products to applications, the service apparatus 20 collects at least one piece of information among keywords, targets, and user information of products from a DB, and automatically matches products to optimal applications based on the collected information.

The various technologies described in this specification can be implemented as digital electronic circuitry, computer hardware, firmware, software, or combinations of these. The technologies can be implemented as a computer program, that is, an information carrier, for example, a computer program typically embodied in the form of a machine-readable storage (computer-readable medium) or a radio wave signal, to process operation of a data processing device, for example, a programmable processor, a computer, or a plurality of computers, or to control the operation. The computer program can be recorded in any form of program languages including a compiled language and an interpreted language, and can be developed in any form including an independent program or a module, a component, a subroutine, or any other unit suitable for use in a computing environment. The computer program may be deployed to be processed by one computer or multiple computers in one site, or distributed across multiple sites and interconnected through a communication network.

Operations of the method can be performed by one or more programmable processors which execute a computer program to perform functions by operating on-input data and generating an output. Also, operations of the method can be performed by special purpose logic circuitry, for example, a field programmable gate array (FPGA) or an application-specific integrated circuit (ASIC), and an apparatus can be implemented as the special purpose logic circuitry.

Processors suitable for the execution of a computer program include, for example, both general and special purpose microprocessors, and any one or more processors of any kind of digital computer. In general, a processor will receive instructions and data from a read-only memory (ROM), a random access memory (RAM), or both. Elements of a computer may include at least one processor for executing instructions and one or more memory devices for storing instructions and data. In general, a computer may include one or more mass storage devices, for storing data, for example, magnetic, magneto-optical disks, or optical disks, may receive data from them, may transmit data to them, or may be coupled to them to transceive data. Information carriers suitable for embodying computer program instructions and data include magnetic media, e.g., hard disks, floppy disks, and magnetic tapes, optical media, e.g., compact disk ROMs (CD-ROMs) and digital video disks (DVDs), magneto-optical media, e.g., floptical disks, semiconductor memory devices, e.g., RAMs, flash memories, erasable programmable ROMs (EPROMs), electrically erasable programmable ROMs (EEPROMs). The processors and the memories may be supplemented by or incorporated in special purpose logic circuitry.

While this specification includes details of a plurality of specific implementations, these should not be understood as limitations of any invention or the scope to be claimed, but should be understood as descriptions of features that can be peculiar to specific embodiments of the specific invention. Specific features described herein may be implemented by being combined in a single embodiment in the context of an individual embodiment. On the other hand, various features described in the context of a single embodiment may be implemented individually or in appropriate sub-combinations in a plurality of embodiments. While features may work in specific combinations and may be described as initially claimed so, at least one feature may be excluded from a claimed combination in some cases, and the claimed combination may be changed to a sub-combination or a modification of the sub-combination.

Similarly, although drawings illustrate operations in a particular order, this does not mean that these operations should be performed in the illustrated particular order or sequence or that all illustrated operations should be performed to obtain a desired result. In a particular case, multitasking and parallel processing may be advantageous. Separation of various system components in the above-described embodiments does not mean that such separation is required for all embodiments. In general, described program components and systems may be integrated in a single software product or may be packed in multiple software products.

Preferred embodiments for exemplifying the technical spirit of the present invention have been described and shown above, but the present invention is not limited to shown and described configurations and effects. Those of ordinary skill in the art would appreciate that various changes and modifications of the present invention can be made without departing from the technical spirit. Therefore, it is to be understood that all suitable changes, modifications, and equivalents fall within the scope of the present invention.

The present invention provides product information related to a product displayed on an execution screen of a game or an application, and a link to a sales site in which it is possible to purchase the product. Accordingly, by providing product information related to a product displayed on an execution screen provided through a game or an application and additionally providing discount information of the product when advertising information corresponding to the product information is selected, it is possible to simplify a procedure for a product purchase and increase benefits from the product purchase. In addition, product sellers can expose their products to innumerable game or application users. Further, users can purchase products matching their interests at low prices. There is enough possibility to commercialize or sell the present invention, and the present invention can be clearly implemented in practice. Consequently, the present invention has industrial applicability.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A service apparatus comprising:
a service communication unit configured to transceive data for providing an application and data related to product sales through the application by communicating with at least one terminal;
a service storage configured to store an execution screen provided through the application, product information provided on the execution screen, advertising information related to the product information, and detailed information matched to the advertising information; and
a service controller configured to collect and provide the information on at least one product related to the execution screen provided through the application, check the advertising information corresponding to the collected product information according to a request of the terminal during execution of the application, provide the detailed information on the advertising information when the advertising information is selected, and make a sale of the product according to a request of the terminal.

2. The service apparatus of claim 1, wherein the service controller checks products previously registered in a product pool by a plurality of product sellers, selects the at least one product to apply to the application from among the products registered in the product pool, and applies the selected product to the application.

3. The service apparatus of claim 1, wherein the service controller requests a plurality of product sellers to register a specific product or is requested to register the specific product by the product sellers, and determines whether or not to register the product.

4. The service apparatus of claim 1, wherein the service controller automatically selects an optimal product by checking at least one of a keyword, a target person, and user information of a product matched to the specific application, and applies the selected product to the application.

5. A method of providing a product using an application, the method comprising:
providing, by a service apparatus, an application to at least one terminal;
collecting, by the service apparatus, product information on at least one product related to an execution screen provided through the application;
checking, by the service apparatus, advertising information corresponding to the collected product information according to a request of the terminal during execution of the application;
transmitting, by the service apparatus, the advertising information to the terminal;
providing, by the service apparatus, detailed information on the advertising information when the advertising information is selected; and
making, by the service apparatus, a sale of the product according to a request of the terminal,
wherein the collecting of the product information further comprises retrieving, by the service apparatus, a product matched to at least one of a user tendency and a supporting language and country corresponding to at least one of a game keyword, a total number of downloads, a daily number of users, a target sex, a target age band, and a country-specific download ratio.

6. The method of claim 5, wherein the product information includes information corresponding to at least one of a product name, a detailed page uniform resource locator (URL), a product image, a category, a quantity, and a time limit.

7. The method of claim 5, wherein the making of the sale comprises:
receiving, by the service apparatus, a signal for requesting payment for the specific product from the terminal;
checking, by the service apparatus, discount information related to the product according to the request;
transmitting, by the service apparatus, the checked discount information to the terminal; and
making, by the service apparatus, the sale of the product through a sales site using the discount information.

8. A computer-readable recording medium storing a program for performing operations of:
providing an application to at least one terminal;
retrieving a product matched to at least one of a user tendency and a supporting language and country corresponding to at least one of a game keyword, a total number of downloads, a daily number of users, a target sex, a target age band, and a country-specific download ratio, and collecting information on at least one product related to an execution screen provided through the application;
checking advertising information corresponding to the collected product information according to a request of the terminal during execution of the application;
transmitting the advertising information to the terminal;
providing detailed information on the advertising information when the advertising information is selected; and
making a sale of the product according to a request of the terminal.
